(19) United States
(12) Patent Application Publication
(10) Pub. No.: US 2004/0112415 A1
(43) Pub. Date: Jun. 17, 2004

(54) Walkable leg crutch

(76) Inventors: Khalil C. Shamieh, Suisun, CA (US); Edward A. Shamieh, Suisun, CA (US)

Correspondence Address: WILLIAM S. BERNHEIM, 255 N. Lincoln Street, Dixon, CA, 95620, US

(21) Appl. No.: 10/315,305

(22) Filed: Dec. 11, 2002

(51) Int. Cl. A61H 3/02

(52) U.S. Cl. 135/68

(57) ABSTRACT

A two legged crutch having a thigh cradle and a shin cradle to allow hands free ambulation by holding the hip joint and knee of an injured leg in a bent attitude to transfer weight directly to the ischium.

### BACKGROUND OF THE INVENTION

1. Field of the Invention

This invention relates generally to crutches and more specifically to leg support crutches designed to permit ambulatory movement by a patient recuperating from an injury or surgery to the foot, ankle, knee, or lower leg.

2. Description of the Prior Art

As needed following an injury or surgery to a foot, ankle, knee, or lower leg, a patient commonly uses a pair of crutches to support himself or herself when recuperating. The crutches aid the patient when walking by supporting the weight otherwise carried by the injured limb.

A typical approach is to use a pair of crutches. The injured member is held in a bent position so as not to come into contact with the floor and a crutch is placed to each side of the body to extend into the arm pit area with the weight otherwise supported by the injured member assumed by the hands of the person placed on a cross member of the crutch. Unfortunately, with this approach, the person usually has discomfort in the arm pit areas, shoulders, and in the hands. Also, holding the member in a bent position is trying and leads to discomfort. Another disadvantage is the unavailability of the hands to do their normal tasks. Transporting objects is a normal task that becomes complicated by the use of crutches.

A number of efforts have been made to design a hands free crutch that straps in some manner to the injured member to transfer weight otherwise carried by it to the knee or thigh. Examples of these are shown in U.S. Pat. Nos. 5,941,263, 5,575,299, 5,300,595, and 5,178,595. For extended use, these examples have drawbacks. They fail to satisfactorily minimize stresses on the knee, distribute the forces that bear on the thigh, or optimize stability for ambulatory movement.

### SUMMARY OF THE INVENTION

It is the object of this invention to provide a means for hands free support of body weight, bypassing the entire leg. Another object is to provide a brace allowing hands free walking. The walkable brace is attached to the lower leg and thigh in such a manner as to transfer the weight to the ischium bone.

These and other objects and advantages will be apparent to those skilled in the art in light of the following disclosure, claims and accompanying drawings.

### BRIEF DESCRIPTION OF THE DRAWINGS

FIG. 1 is a not-to-scale drawing of a crutch in accordance with the invention.

### DESCRIPTION OF THE PREFERRED EMBODIMENT(S)

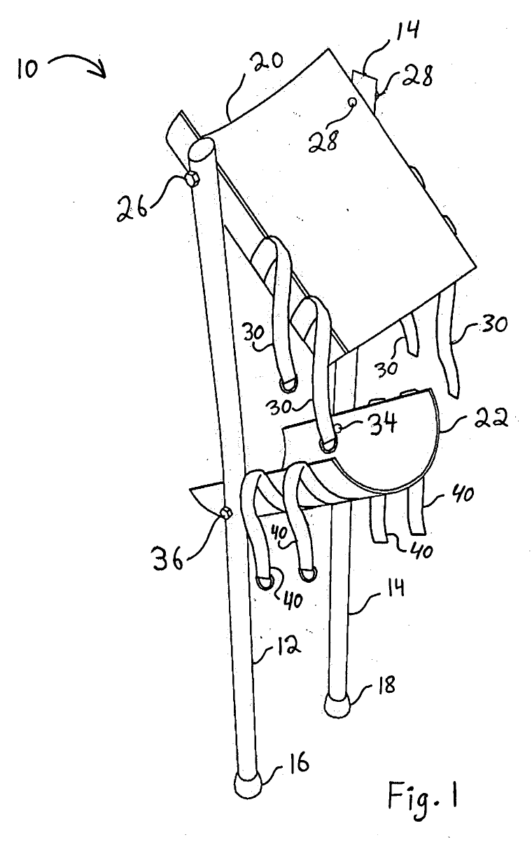

Referring to FIG. 1, a two legged crutch 10 of the invention includes two vertical struts 12 and 14 made of a suitable and preferably light weight high strength material, such as aluminum, alloys, or other suitable materials. Struts 12 and 14 have at the lower end of each strut 12 and 14 a respective cap 16 and 18 for contacting the ground. Connected to each strut 12 and 14 and extending between the struts 12 and 14 and maintaining the struts 12 and 14 spaced apart and generally extend in parallel are an upper thigh cradle 20 and a lower shin cradle 22.

The thigh cradle 20 has a cross section approximating a half circle and in use will be padded. The padding material may be any suitable material, and may be custom formed to fit the specific contour of the user's thigh. The thigh cradle 20 is sized for the under side of a person's thigh. Thigh sizes vary significantly with the height and weight of a person. A typical diameter across the thigh cradle 20 is 7 (seven) inches. The opposite sides of the thigh cradle 20 rotationally attach to respective struts 12 and 14 with respective attaching means 26 and 28 such as a nut and bolt incorporating a bearing or other suitable attaching device. The thigh cradle 20 is provided with two Velcro straps 30 which are intended to secure a person's thigh in the cradle

The shin cradle 22 has a cross section approximating a half circle and in use will be padded. The shin cradle 22 is sized for the front of a shin. Shin sizes vary with the weight of a person. Accordingly, padding employed in shin cradle 22 may be of any suitable material and may be contoured to fit the specific shape of the user's shin for comfort and/or stability requirements. A typical diameter across shin cradle 22 is 4 (four) inches. The opposite sides of the shin cradle 22 are rotationally attached to respective struts 12 and 14 with respective lower attaching means 34 and 36 such as a nut and bolt, such as a nut and bolt incorporating a bearing, or other suitable attaching device. Opposite sides of shin cradle 22 are respectively attached to struts 12 and 14 in such a fashion that the struts 12 and 14 both are spaced apart and generally extend in parallel. The shin cradle 22 is also provided with velcro straps 40 which are intended to be used to secure a person's shin in the cradle so that the thigh and shin of one leg of a person is secured to the crutch 10.

The struts 12 and 14 are equal in length and will vary depending on the height of the person using the crutch. However, in an alternative embodiment, the struts 12 and 14 may merge at a predetermined point below shin cradle 22, effectively becoming and resulting in a single strut extending to contact the ground, for certain higher mobility applications.

In substitution of caps 16 and 18 may be rocker type soles for alternative mobility options. Further, in an alternative embodiment, struts 12 and 14 may be constructed not straight, i.e. not linear, but rather are constructed to follow a path defined by the outline of the user's bent leg when the leg is in the crutch-employing position. In such an embodiment, at least one pivot point, for example that pivot point disposed about by a nut or bolt 34 or 36, coincides with the knee region of the bent-leg-outline contoured struts 12 and 14. Such knee region disposed pivot point is positioned and constructed in such a fashion as to allow for back and forth movement of the thigh cradle 20. With this goal in mind, a spring loaded arm may engage thigh cradle 20 to struts 12 and 14 in such fashion as to maintain support of the user's weight on their thigh during the back and forth walking movements. A locking device may be disposed with and cooperatively coupled to either or both pivot points so as to allow locking the crutch in a desired or critical position. Such locking device may further limit the movement of the struts 12 and 14 beyond a specified range, so as to inhibit possibly damaging motion, and be activated by either the presence of or the absence of a minimum predetermined amount of weight, and deactivated by the absence of the chosen activation criteria.

Certain height variation can be accommodated by placement of bolt holes passing through struts 12 and 14 at spaced intervals of approximately an inch along the struts 12 and 14. For a child the strut length would be about 28 inches and for a tall individual would be about 42 inches. In use the height of the struts and attachment points of the thigh cradle are chosen so that the user's hips are level.

When strapped into and secured within thigh cradle 20 and shin cradle 22 the user's knee should be at an approximate 45° bend from the straight position for comfort. For comfort the hip joint is bent forward about 30° from the straight position so that the knee is forward of the torso. Bending of the hip joint is crucial for comfort and long term use. If the hip joint is unbent all weight is transferred up through the knee which is uncomfortable. It is the bending of the hip joint which allows the thigh to support the user's weight, and the angle of the knee in conjunction with a bent hip which allows the shin to likewise participate in supporting the user's weight.

Although the invention has been shown and described with respect to preferred embodiments thereof, it should be understood by those skilled in the art that various changes and omissions in the form and detail thereof may be made therein without departing from the spirit and scope of the invention as defined in the appended claims.

We claim:

1. A leg support crutch that permits ambulatory movement of a user recuperating from a foot, ankle, lower leg, or knee injury or surgery by transferring the user's body weight from the floor directly to the ischium on the injured side by-passing the leg, via a crutch comprising:
two struts having an end for contacting the ground selected from a group consisting of (i) a single point for contacting the ground and (ii) a plurality of points for contacting the ground, and extending between the two struts and rotationally attached to the struts are a thigh cradle and a shin cradle, the shin cradle being closer to the contacting end and sized smaller than the thigh cradle; and each cradle attached with a removable strapping means for securing (i) a thigh in contact with the thigh cradle and (ii) the shin of the same leg in contact with the shin cradle; and the spacing of the cradles and height of struts is such that the hips of the user are level and the hip joint of the strapped leg is bent forward at about 30° forward of vertical.

2. The crutch of claim 1 wherein the spacing of the cradles is such the knee of the strapped leg is bent 45° from the straight position.
